(19) United States
(12) Patent Application Publication
(10) Pub. No.: US 2014/0006192 A1
(43) Pub. Date: Jan. 2, 2014

(54) SELECTIVE ESCROW OF FUNDS BASED ON TRANSACTION RECEIPTS

(71) Applicants: Owen H. Brown, Montclair, NJ (US); David N. Joseph, Bowdoinham, ME (US)

(72) Inventors: Owen H. Brown, Montclair, NJ (US); David N. Joseph, Bowdoinham, ME (US)

(73) Assignee: DAVO FINANCIAL SERVICES LLC, Montclair, NJ (US)

(21) Appl. No.: 13/537,779

(22) Filed: Jun. 29, 2012

(51) Int. Cl. G06Q 40/00; G06Q 20/40; G06Q 20/20; G06Q 20/10

(52) U.S. Cl. 705/19; 705/39; 705/44

(57) ABSTRACT

A computer-implemented method is provided for segregating funds associated with transactions of a seller. Such method may comprise storing data relating to a seller; and determining a sales amount corresponding to transactions of the seller associated with a closeout period. The method may include determining an escrow amount based on the sales amount and a tax rate applicable to the transactions. An instruction can be transmitted to an electronic funds processor (EFP) to direct the EFP to credit an escrow account with the escrow amount.

### FIELD OF THE INVENTION

The present application relates to a computer-implemented method and system for segregating funds or for paying out funds associated with at least one sale of a seller, e.g., a merchant, such as for the payment of sales tax or other obligation of a seller.

### BACKGROUND OF THE INVENTION

Computers facilitate with high speed and accuracy a vast myriad of commercial transactions, including credit card transactions. Sellers of goods and services are responsible for collecting sales tax or other taxes and for periodically making payments to the appropriate taxing authority of the tax receipts collected on their sales. These periodic payments by the sellers of the accumulated sales taxes may be done monthly or quarterly for local, state, provincial, federal or national taxing authorities, or on another schedule. At the end of such periods, some sellers find that they may have spent funds, or have otherwise failed to segregate and retain sufficient funds to make the required tax payment to the taxing authority.

There is a need for an improved method by which a seller may segregate or escrow funds collected from sales for payment of sales tax or other taxes owed to a tax authority. The methods disclosed herein facilitate collection, escrowing and payment to be performed by one or more third parties, e.g., with a financial or other institution possibly holding escrow funds, so that seller's direct participation may be limited to a passive role. The method in some cases can generate appropriate payment forms and reports for submission to the taxing authority.

### SUMMARY OF THE INVENTION

A computer-implemented method is disclosed for segregating and/or impounding escrow funds by an electronic funds processor (EFP) associated with sales transactions of a seller, e.g., a merchant, during a close-out period. The amount of the segregated funds can be determined in relation to an amount associated with one or more transactions of the seller during a particular closeout period, which may be in the form of bank card transactions, as defined herein. The amount of the segregated funds can also be determined relative to an amount of non-bank card transactions (such as cash or check transactions) as also further defined herein, or a combination of the bank card transaction and non-bank card transactions. The escrowed or segregated funds can be paid for sales taxes or other taxes due for the transactions or for a variety of seller obligations. The funds can also be set aside for later payment of sales or use taxes or other taxes due for the transactions, or for paying a variety of other seller obligations.

The method may include using at least one computer system: determining a sales amount corresponding to determine a sales amount corresponding to one or more transactions of a seller associated with a closeout period. The transactions may be associated with at least one sales registry device as described more fully below. The method may then determine an escrow amount based on the sales amount and a tax rate applicable to the one or more transactions. An instruction can be transmitted to an EFP to direct the EFP to credit an escrow account with the escrow amount when the sales amount equals or exceeds the escrow amount. As the escrow account is set up for a particular purpose, e.g., for the payment of a tax or other obligation of the seller, the method can be performed in a way that keeps the seller from accessing the funds in the escrow account except in certain circumstances as defined by law.

One aspect of the method contemplates other applications in which a seller may desire or may otherwise be required to withhold funds associated with sales transactions (for example, by local, state and federal tax authorities, judicial authorities, and payees who have an agreement with the seller or who may have received a legal judgment against a seller). The method also contemplates segregating or impounding escrow funds for paying “back taxes” owed by a seller, e.g., a merchant. As used herein, “back taxes” means taxes owed for time periods prior to a current time period. Back taxes may include one or more of back sales taxes or back use taxes, back payroll taxes, back income taxes, or back property taxes or back real estate taxes, among others. In addition, the method contemplates segregating or impounding funds related to a savings account of a seller. Furthermore, the method contemplates segregating or impounding funds to facilitate payments of accounts receivable, merchant rents, and real estate taxes.

### BRIEF DESCRIPTION OF THE DRAWINGS

A more complete understanding of the invention may be obtained by reading the following description of specific illustrative embodiments of the invention in conjunction with the appended drawing in which:

FIG. 1 is a schematic diagram illustrating a method for obtaining authorization for a bank card sale;

FIG. 2 is a schematic diagram illustrating a method according to an embodiment of the invention;

FIG. 3 is a block diagram illustrating a computer system which can be used in a method according to an embodiment of the invention;

FIG. 4 is a schematic diagram illustrating a method according to an embodiment of the invention;

FIG. 5 is a schematic diagram illustrating a method according to an embodiment of the invention;

FIGS. 6A-6C illustrate various embodiments of the invention in examples with bank card sales, and with non-bank card sales; and

FIG. 7 is a schematic diagram illustrating a method according to an embodiment of the invention.

### DETAILED DESCRIPTION OF THE PREFERRED EMBODIMENTS

The following detailed description includes a description of the best modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention.

Frequent reference is made herein to transactions involving the use of “bank cards”, as well as “non-bank card” transactions which do not involve the use of bank cards. As used herein, a “bank card” is a “credit card” or a “debit card”. Further, as used herein, a “credit card” is a card that represents a line of credit extended by an institution, e.g., a bank or financial institution or other business that lends, which card a customer can use to pay for purchases from a seller, most typically after obtaining credit authorization for the transaction from the lender at the time of the transaction. The credit card in some cases may be issued by the seller rather than by a bank or other financial institution, and is nevertheless included herein within the definition of “bank card”. Further, as used herein, a “debit card” is a card linked to a financial or other depository institution to facilitate customer withdrawals primarily from a deposit account, or investment account, for example, although the customer may be permitted to draw upon other resources such as a line of credit when the balance available in the account is insufficient for the withdrawal.

By contrast, as used herein, “non-bank card” transactions refer to transactions for which payment is made in cash or in one or more of a variety of financial instruments such as personal check, bank check, traveler's check, pre-paid card, e-wallet, gift card as defined below, or other such financial instrument which is not a “bank card” as defined herein.

Reference is made herein to a “merchant” and a “seller”. As used herein, a “seller” is anyone who sells an item, which may be goods, services or a rental or lease, for example, and for whom a portion of funds associated with at least one sale can be segregated and/or paid to a third party in accordance with the embodiments of the invention described herein. As used herein, a “merchant” is a “seller” as defined herein who, in particular, is authorized to receive bank card payments from customers directly through an Acquirer. Summarizing, all merchants are sellers; however, not every seller is a merchant. As used herein, an Acquirer is an institution, most typically a financial institution such as a bank, which facilitates the authorization of and entry of bank card transactions, and facilitates the associated transfers of funds between institutions such as bank card issuers and sellers, e.g., merchants. An Acquirer often is a separate institution from either the seller or the bank card issuer. However, in the case of AMEX or Discover, the Acquirer can be incorporated in the same institution as the bank card issuer. In another example, such as when the seller itself issues bank cards, the Acquirer may be incorporated in the same institution as the seller.

At least some of the embodiments herein can be utilized to make funds available from the proceeds of transactions of a seller, whether or not the seller has merchant status, and without considering whether there is a particular number, frequency or volume of sales. Accordingly, particular embodiments of the invention may apply to a small or online seller of goods or services with relatively small or infrequent sales. The seller in some cases may rely upon payment intermediary services such as PayPal (a service provided by an entity owned by Ebay Corporation) and Square (a service of Square, Inc.) and the like, which perform and/or facilitate electronic processing of funds, if the seller cannot or does not wish to meet credit and financial requirements for merchant status in bank card networks, e.g., Visa/MC, AMEX, or Discover. Currently, EFPs are commonly used in the industry for managing bank card transactions between merchants and banks. This function often includes the collection of associated service fees by the EFP on behalf of the bank card provider (for example, Visa and MasterCard) for electronic funds transfer (EFT) to a merchant account. Alternatively, in the case of American Express (AMEX) and Discover, service fees are first deducted before net sales (less service fees) are EFT deposited by AMEX and Discover in the merchant account.

In a particular example, the bank card can incorporate an “EMV” chip, EMV being an acronym for a standard adopted by Europay, Mastercard and Visa, and which are now in use in Europe and may soon be in use in the United States as well. An EMV chip card enables its holder to obtain authorization for a transaction using information recorded on the bank card itself; specifically, as recorded on an integrated circuit (“IC”) chip incorporated in the bank card. An EMV chip card in this way allows a transaction to be authorized for payment via the EMV chip card even when the merchant is unable to electronically transmit an authorization request for the transaction to an Acquirer. Information about the transaction that is collected by the merchant can then be forwarded at some later time to the Acquirer, e.g., at the end of a closeout period, and the Acquirer can then credit an escrow account and the merchant account with the applicable portions of the transaction proceeds. Even in systems which require electronic authorizations to be provided from the card issuer, EMV chip cards can also be used to verify the authenticity of a bank card, because the security features in such cards are more difficult to defeat than traditional bank cards that record information only on magnetic stripes. Specifically, one frequent way that transactions using EMV chip cards are approved involves the customer entering a personal identification number (PIN) when presenting the EMV chip card to the seller, wherein the transaction is only approved when the PIN matches the information stored in the IC chip on the card.

In one example, sales or other transactions made through a payment intermediary service such as PayPal or Square can be performed using an EFP to obtain payment authorization and process the payment, with the processing of fees or percentages from amounts handled by the EFP and the payment intermediary.

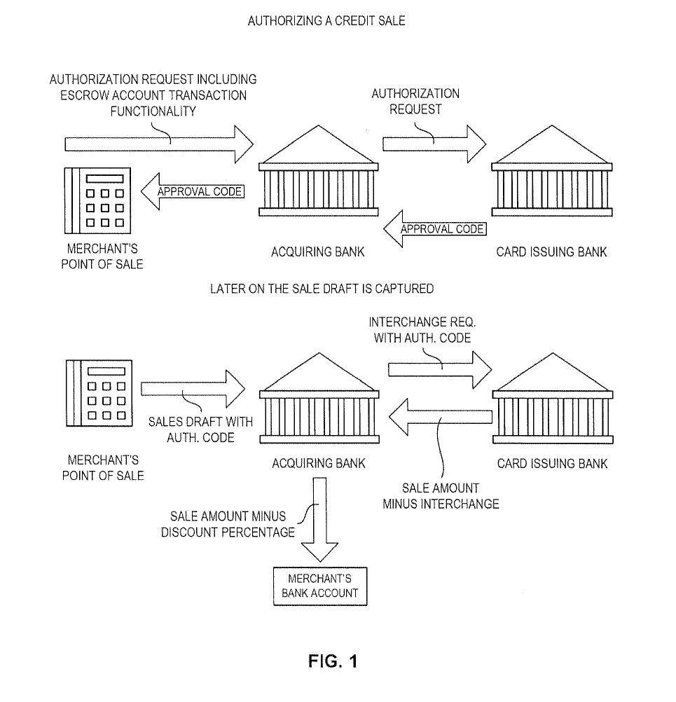

Similarly, the methods described herein may be applied to funds paid to the seller in the form of instruments such as personal checks, bank checks, or money orders. In this case, the EFP can be an element of an electronic check processing service which processes checks and money orders received by the seller or merchant, which in some cases can be done by capturing an image of the check or money order on a point of sale (POS) terminal, or other sales registry device as described below, and transmitting the captured image to the check processing service for payment. An example of a currently practiced method of authorizing a bank card purchase and processing the payment associated with the purchase is illustrated in FIG. 1. As shown therein, authorization for a bank card sale is requested from a sales registry device, e.g., POS device, of a merchant, which is then transmitted to an Acquirer, labeled in FIG. 1 as “acquiring bank”, and from there to the card issuing bank for the customer's bank card. If authorized, an approval code is transmitted from the card issuing bank back to the Acquirer, and approval is communicated from the Acquirer to the sales registry device of the merchant. Later on, the sales draft is captured. At the end of a day, or at the end of a predetermined period, which can be more or less than a day, the card issuing bank settles an account with the Acquirer for transactions associated with the predetermined period. The Acquirer can credit the merchant's bank account with the amount of the sale minus a percentage which can be charged based on the type of bank card used, e.g., Visa, MasterCard, AMEX or other card.

In another example, a seller can accept value represented by a gift card in exchange for an item sold by the seller. Such gift card, which often is issued by the seller or corporate affiliate of the seller, may represent value, similar to store credit, which is promised by the seller to the customer and which the customer can use to make purchases from the seller under certain conditions authorized by the seller. A proposed transaction involving such gift card can be checked for approval, for example, by swiping the gift card at a bank card terminal, which prompts a database of the seller associated with the gift card to be checked to determine whether the gift card has sufficient value for the transaction to be approved. The methods and systems according to the embodiments herein are not limited to the processing of transactions and payments using traditional POS terminals, which typically have very specific hardware and are typically found at fixed locations in a store or other establishment operated by the merchant.

Traditionally, POS terminals have relied on hard-wired network communications between them and a management interface through which communications can be sent and received for authorizing bank card payments from a customer and the like. Rather, a device on which sales and payments, e.g., bank card payments are processed, can be a “sales registry device” which can be implemented in a number of different ways. In one example, the sales registry device can have a wireless communication interface such that the sales registry device is configured to communicate information for authorization of and processing of transactions and payments over the wireless communication interface. In another example, the sales registry device may include or utilize a wireless communication interface such as can be provided on a portable computing platform that is configured to operate via battery power, such as commonly used in authorizing and processing payments and transactions for some retail electronic stores, rental car agencies and in restaurants, particularly in Europe. For example, the portable computing platform may be configured to process transaction information and payments on battery power for a period of time of one hour or more. In a particular example, the sales registry device can be implemented using a general purpose computer (a microcomputer such as a desktop computer, laptop computer, or otherwise) having software instructions stored in a storage accessible to the microcomputer which can be executed by one or more processors of the computer to authorize and process a transaction.

In one example, the sales registry device can have an open industry platform that is configured to permit user-reconfiguration by installation of program software which may be available from various vendors. In one example, the sales registry device can be implemented using a mobile computing device having a more specialized function such as a tablet computer, or a smartphone such as devices that have cellular or other telephone function. The mobile computing device can have an open industry platform which is user-reconfigurable by installation of program software which may be available from various vendors. Without limitation, examples of such mobile computing devices include tablet computers such as iPad™ (Apple Computer Corp.), other tablet computers, and smartphones such as iPhone™ (Apple Computer Corp.) Android™-enabled devices (Google) and Blackberry™ (Research In Motion) devices. In a particular example, payment authorization and processing can be facilitated using a mobile card reader that can be electrically connected, or otherwise linked or paired with the mobile computing device. In one example, the mobile computing device may be capable of sustaining operation on battery power for periods of one to several hours or more while processing sales transactions and payments therefor.

In accordance with an embodiment of the present invention, a selective escrow method is disclosed in which a third party (e.g., the EFP) may collect seller or merchant funds to be escrowed for payment of a tax associated with the transaction, such as sales tax, for example. Initially, information entered at a bank card terminal (for example, entry of the bank card number by swiping, and purchase amount and card expiration by keypad entry) is received by the EFP and forwarded to a bank card issuer for authorization. Authorization is provided (for example, as indicated by an issuer-assigned confirmation number) and forwarded by the card issuer via the EFP to the merchant for storage in the bank card terminal. At the end of a transaction period also referred to as “closeout period” herein (for example, at the end of each day), the merchant may “close out” bank card sales at a POS terminal or bank card terminal associated therewith. As part of the closeout process, the EFP can make one or more payments to the merchant's account based on the sales of that closeout period. Once the EFP has obtained funds from the bank card issuers for one or more transactions in the closeout period, customer sales tax owing is debited from the gross taxable sales, and the net funds are sent on via EFT to the merchant's account or to another provider (such as American Express) for delivery to the merchant's account. The debited tax portion is credited to an escrow account for making future tax payments.

Because sales tax owed can be determined from the number, nature and place of sales, instructions can be provided by a computer system to the EFP to automatically facilitate the escrow process in order to relieve the seller or merchant from having to deal with holding funds aside and otherwise manage the process of making sales tax payments. Software currently used by the EFP to manage the bank card process for debiting fees can be adapted to carry out the instructions to direct funds to an escrow account, or otherwise directly to a tax authority in full or partial payment of a tax, for example.

Once deposited in the escrow account, funds may be transferred at defined intervals to tax authorities (or other owed parties) by the escrow agent in order to meet the seller's tax payment obligations. The escrow agent may be compensated for this service by retaining interest earned on funds (“float”) in the account in between payment periods.

In one embodiment, the method can be implemented by transmitting an instruction to the EFP to cause the EFP to credit an escrow account with an escrow amount determined based on a sales amount of the seller and an applicable tax rate. For example, a computer system according to an embodiment of the invention which oversees the escrowing of funds can generate and transmit an instruction to the EFP to credit the escrow account based on the transactions of the seller. The EFP can then act on the instruction, i.e., credit the escrow account with the amount stated or determined in accordance with the instruction. In one example, the EFP can use the same type of equipment, e.g., program software and/or hardware that the EFP otherwise uses, to deduct the bank card provider fees charged to the seller for account transactions.

Bank card providers, e.g., Visa/MC, AMEX and Discover, charge fixed or variable fees which often are charged as a percentage of the value of a transaction. Frequently, the fees are charged to each seller or merchant for each batch of bank card transactions corresponding to a particular closeout period which can be one day or a period of time shorter or longer than one day.

An embodiment of the invention provides a method by which sales or use tax due on transactions between a seller and its customers can be debited by an EFP from bank card transactions, and escrowed, e.g., by a third party (for example, a major bank or other financial institution), and thereafter paid to the tax authority, with little or no imposition of burden on the seller. In such embodiment, this method can be implemented by the EFP crediting an amount from the proceeds of one or more bank card transactions of the seller to an escrow account of the seller, or perhaps by the EFP crediting an account of the tax authority rather than an escrow account. This can be done because the EFP is already processing bank card transactions in order to credit the gross amount of a bank card transaction, less the bank provider's fees, to the seller's bank account. The method can also account for sales transactions that are exempted from paying customer sales tax so as to avoid setting aside funds or making payments to a tax authority for such non-taxable transactions.

Customer sales and use tax owed for non-bank card transactions (for example, payments made with physical currency, personal checks, bank checks, travelers checks, pre-paid cards, e-wallets, money orders, gift checks, gift certificates, gift cards such as described above, or other foreseeable items of monetary value) can also be accommodated by the method according to an embodiment of the invention. Sales and use tax can also accrue for barter transactions, which is the direct exchange of goods or services for other goods or services, i.e., where the goods or services being exchanged are not first converted into one or more items having a universally recognized monetary value such as physical currency, personal checks, bank checks, gift checks, or gift cards such as described above, for example. Barter transactions are another form of non-bank card transactions which can be accommodated by the method according to an embodiment of the invention. A number of approaches for escrowing or paying customer sales or use tax accruing from any or all such transactions or for the payment of other obligations of the seller or for effecting a seller savings account are described in the following.

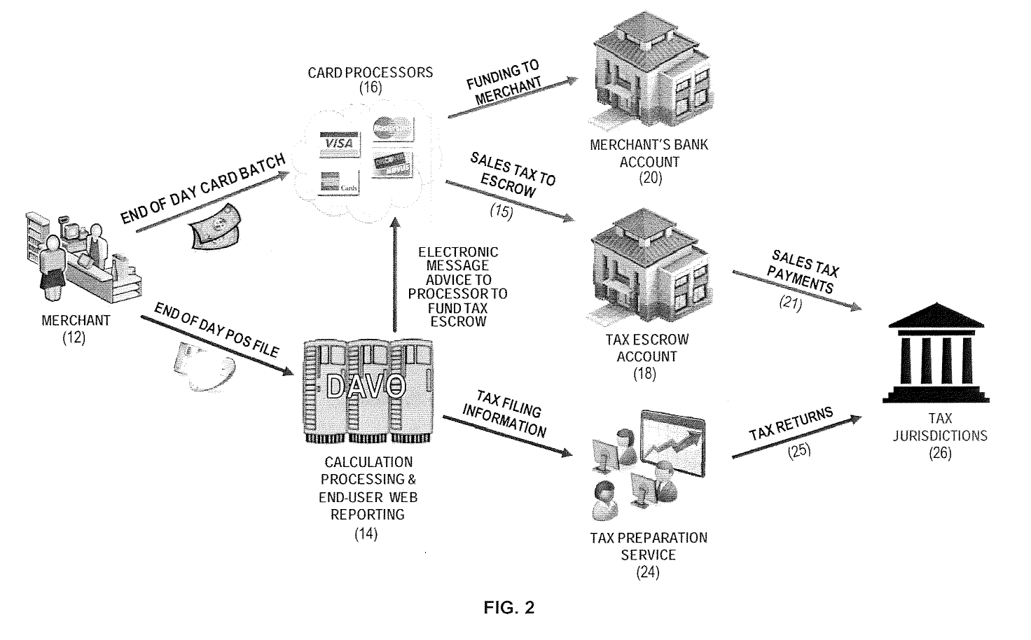

FIG. 2 illustrates a method of segregating or escrowing funds according to an embodiment of the invention. The different entities that handle the processing of funds are illustrated therein. As seen in FIG. 2, a merchant (12) operates one or more sales registry devices on which sales transactions and payments are handled, and on which payment authorization can be obtained, such as through use of a card reader, as described below.

In one example, the sales transactions of a seller or merchant can be processed through one or more POS terminals for a closeout period such as a day. At the end of the closeout period after closing out the one or more POS terminals and sending out data regarding the transactions for the day, funds can be set aside for the payment of taxes, or alternatively, paid directly to tax authorities based on data recording the amount of sales at the one or more POS terminals during the closeout period. As described further herein, the calculation of taxes and the directing of funds into escrow, or alternatively to be paid directly to tax authorities, can in one example be done automatically via a computer system managing the process which can transmit an instruction to an EFP or institution where the seller banks. Alternatively, in a particular example which can be referred to as “forced entry”, the seller or merchant can select a particular amount of funds to be escrowed or paid to taxes for the closeout period, and the computer system can then escrow or pay such amount to taxes without further intervention by the seller.

As further seen in FIG. 2, the transaction data associated with the closeout period can be forwarded from the POS terminal to a computer system (14). In one example, the sales transaction data can include Z-file data forwarded, e.g., “pushed” from or retrieved, e.g., “pulled” from a POS terminal of the merchant. The Z-file data can include, for example, data for the most recent closeout period which may indicate some or all of the following: Total Sales, Taxable Sales, Non-Taxable Sales, Tax Exempt Sales and Returns as well as Merchant Identifying Information. Typically, the sales transaction data is forwarded to the computer system after the end of each closeout period, which may occur daily, and the sales transaction data may relate not only to bank card sales, but may also relate to non-bank card sales such as transactions for which payment is made by cash, check, or other source of funds. At the end of each closeout period transaction data relating to bank card transactions during the closeout period are also forwarded to the EFP, which is shown as “Card Processors” (16) in FIG. 2.

The computer system (14) receiving Z-file data from a POS terminal or other sales or transaction data from another type of sales registry terminal, can determine a sales amount which corresponds to one or more transactions of the seller associated with the closeout period. In one embodiment, the sales amount can be associated with a particular sales registry device or can be associated with a particular salesperson, whether or not the particular salesperson utilizes the same sales registry device during the closeout period.

The computer system (14) processes the received transaction data to determine an escrow amount to be segregated or escrowed based on a sales amount during the closeout period. In one example, the escrow amount can be an amount based on a tax rate applicable to one or more transactions to which the transaction data relates. As further seen in FIG. 2, based on the one or more transactions in accordance with the transaction data, the computer system (14) can generate and cause an instruction, e.g., electronic message advice, to be transmitted to the EFP (16). The EFP can then use the transmitted instruction, e.g., electronic message advice, to credit an escrow account (18) with the determined escrow amount, as indicated by “Sales Tax to Escrow” (15) in FIG. 2. In addition, as seen in FIG. 2, the EFP may credit a bank account of the merchant (20) with a portion of the sales amount of the one or more transactions, net of the determined escrow amount.

As further seen in FIG. 2, at some appropriate time interval, which may be determined by a tax reporting interval established by a tax authority, tax payments (21) can be made from the tax escrow account (18) to an applicable tax authority or tax jurisdiction (26). In one example, the tax payments may be only sales tax payments. However, in another example, the tax payments may include an extra payment for back taxes, other taxes, or for other obligations owed by the merchant or seller.

In a particular embodiment, the computer system (14) can transmit an instruction to an institution which manages the tax escrow account to direct the payment of a tax or other amount from the escrow account to a tax authority or other payee. In one example the computer system (14) may direct the institution to credit a payee, e.g., the tax authority with an amount by transmitting an instruction to a second computer system associated with the institution, wherein the instruction may include information representative of an account of the payee and the payable amount to be paid to the tax authority or other payee. In one example, the amount paid to the payee this way can be for payment of taxes as a tax payable amount. As also seen in FIG. 2, from the transaction data the computer system (14) may generate information concerning the volume of sales during a particular tax reporting interval and regarding the taxable transactions thereof. The computer system may register a sales amount for the reporting interval using the accumulated transaction data that can be based upon the Z-file data for each of the closeout periods in the tax reporting interval. This information may include tax filing information which may be made available or provided to a tax preparation service (24). In turn, the tax filing information can be used by the tax preparation service to prepare and submit a tax return (25) to the tax authority (26). Alternatively, and in an appropriate case, the computer system itself may aid in the preparation of a tax return for the tax reporting interval, which can then be approved by the merchant or seller prior to forwarding the same to the “tax authority”.

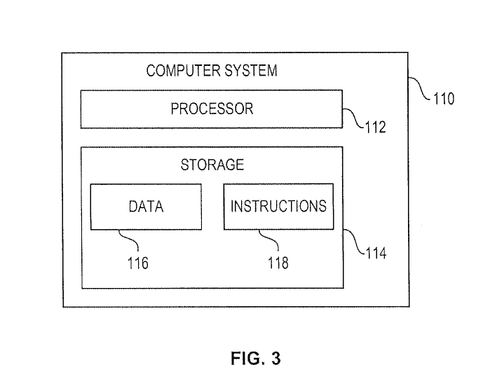

As seen in FIG. 3, an exemplary computer system which may be used to carry out a method according to an embodiment of the invention can include one or more computer or information processing systems 110, each of which may have a processor 112 comprising one or more microprocessors. The one or more computers 110 may each function as a server to serve or transmit data 116 and instructions 118 to other computers. As will be described further below, such computer 110 may exercise a control function to provide an instruction to another computer or EFP to direct that escrow funds be segregated and transferred to an escrow account.

The computer system 110 may comprise special purpose or general purpose computing equipment for carrying out a method of operation in accordance with the embodiment of the invention. Such computer system can control the segregation of escrow funds in the method by generating and transmitting an instruction directing an EFP or institution such as a bank to credit an escrow account based on the transaction of the seller. In particular examples, the computer system can be a computer system independent of a computer system associated with one or more sales registry devices or POS terminals (12, FIG. 2) of the seller, and independent of a computer system or network which implements the EFP (16, FIG. 2). Alternatively, the computer system can be associated with one or the other of a computer associated with one or more sales registry devices or POS terminals (12, FIG. 2), or a computer system or network which implements the EFP (16, FIG. 2).

Each such computer 110 typically has storage 114 available thereto for storing and retrieving information used by the processor 112 within the computer. For example, storage 114 may be used to store data and instructions which are executable by such processor. Storage 114 can include, for example, one or more of various magnetic, solid-state or optical drives, etc., for read-write access to data and instructions. The storage 114 can also include one or more various portable memory media which can be read-write type, read-only type or combination type (e.g., a type of medium designed to be written only once but read many times), which can be recorded or read by electrical, magnetic, or optical means. For example, the storage 114 can include an internal or external memory drive or miniature memory card, e.g., SD card or drive, a compact disc (“CD”) or CD-ROM, digital versatile disc (“DVD”), or magnetic tape media, etc., which are easily and readily interchangeable with other similar media, and on which data or instructions or both can be recorded, read and, in some cases, executed by the computer. The computer system 110 can be connected to additional storage (not shown), e.g., a mass storage device such as a hard-drive, tape-drive or solid-state drive, which can be locally connected thereto, or storage available over a network. The additional storage can in some cases house one or more repositories of data, e.g., databases. In a particular example, storage available to the computer system over a network can be “cloud-based storage.” Cloud-based storage can in some cases be sourced from multiple locations over a network. Cloud-based storage may also permit multiple copies of the same data to be stored at multiple different locations on a network for added security in case of events which impact availability of a particular computer system or the network in which that computer system resides.

Instructions 118 utilized by the computer 110 can be any instructions which are executable either directly by the processor, such as machine language instructions, or which can be rendered directly executable from any computer-readable language, such as from computer-readable and compilable code, or from interpretable code or from a combination of compilable and interpretable code. The data 116 can be handled, i.e., written to storage or retrieved therefrom or modified based on the execution of the instructions 118 by the processor 112.

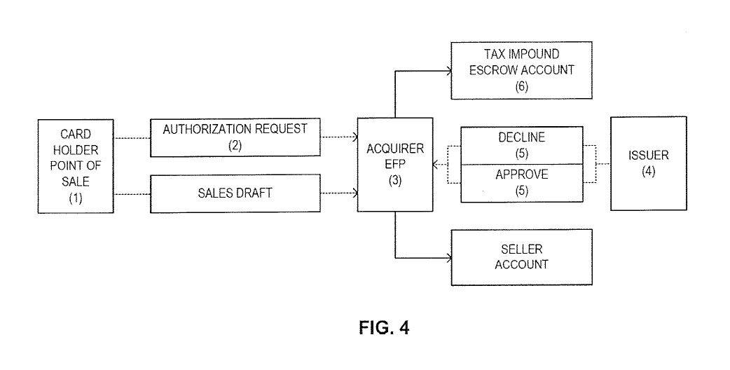

A schematic diagram illustrating another possible implementation of the method is provided in FIG. 4, which can involve the following operations: As seen at (1), the customer making a purchase presents a bank card to the seller, which may be at a point of sale. At (2), the seller can use a sales registry device, e.g., an electronic terminal at a point of sale, or a smartphone, for example, or alternatively a telephone to request authorization to charge the customer bank card for the transaction. At (3) the Acquirer receives the authorization request and forwards it to the bank card issuer. In the case of Visa and MasterCard, the Acquirer can be an institution that is the same as, but is usually independent from the institution, e.g., financial institution or seller that issued the bank card. However, the functions performed by the Acquirer can be part of the same institution as the issuer, such as when the card is from AMEX or Discover. At (4), the issuer receives the authorization request and approves or declines the transaction, which status is then communicated back to the sales registry device or terminal at the seller, as indicated by the notations “Decline (5)” and “Approve (5)” in FIG. 4. When authorization of the transaction is received at the sales registry device, the customer and seller can proceed with the bank card transaction, at which time the customer may sign a sales draft or enter a personal identification number (“PIN”), for example, to complete the sale. Information about the completed bank card transaction can then be collected and forwarded from the sales registry device or POS terminal to the issuer via the EFP, a part of the Acquirer. In turn, based on the amount of one or more transactions within a closeout period of the seller, as will be described more fully below, as seen at (6) the EFP can be instructed to transfer a determined amount of funds into an escrow account for the payment of taxes collected or owed by the seller. For example, a computer system to which data is provided regarding the bank card sales, as well as the non-bank card sales of the seller within the closeout period, can calculate an amount of funds to be escrowed therefrom or paid therefrom to a payee such as a tax authority. Such computer system can transmit an instruction to the EFP to cause the EFP to transfer the funds to an escrow account or to the designated payee.

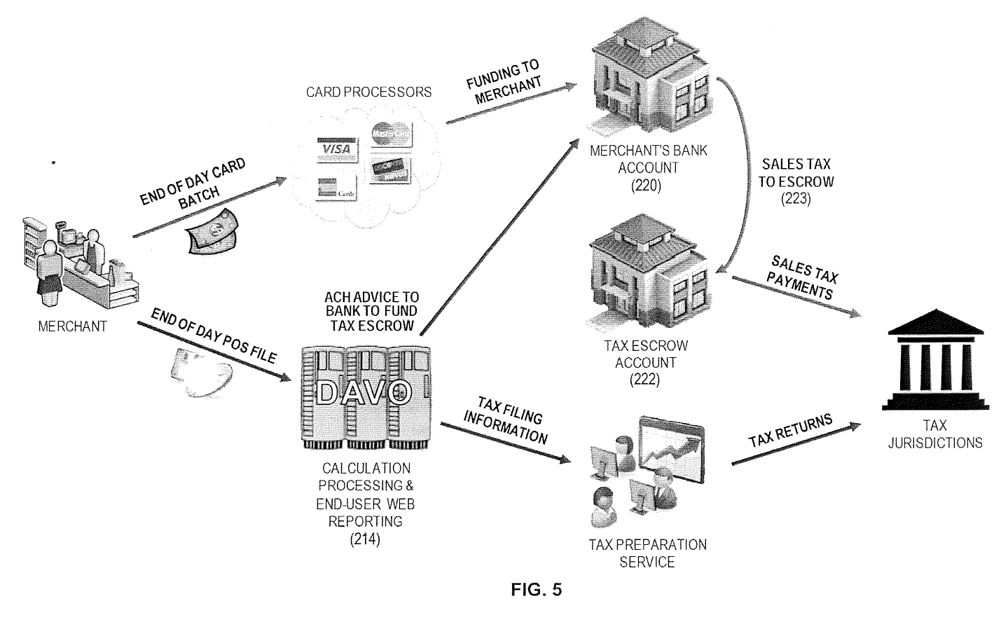

An alternative approach for segregating escrow funds such as for collecting sales or other taxes on transactions including cash transactions is illustrated in FIG. 5. As seen therein, the computer system (214) can transmit an instruction, e.g., an ACH advice to transfer funds to an escrow account. In contrast to the method described above relative to FIG. 2, in this case, the computer system (214) transmits the instruction or ACH advice to an institution at which the merchant has an account (220) to transfer an escrow amount (223) therefrom to an escrow account (222). For example, the computer system (214), after determining an appropriate escrow amount based on the seller's transactions during the closeout period, can generate and transmit an EFT request to the seller's bank to direct the transfer of the escrow amount (223) from the seller's bank account to the escrow account. In one example, the computer system (214) can generate the EFT request to the seller's bank using the Automated Clearing House (ACH) network, i.e., in form of an ACH debit request to the institution which holds the seller's account.

In a particular embodiment, it may be possible for the computer system (214) to direct funds to be transferred from the seller's bank account to the escrow account in the ordinary course of operation when funds are available in the seller's account and when there is no other impediment to transferring money from the seller's account. In addition, the computer system (214) can also transmit an instruction to direct the EFP to transfer the escrow amount to the escrow account in appropriate circumstances. These activities can be performed, in one example, in a failsafe or backup order, in which the computer system may first seek to transfer a determined escrow amount to the escrow account by one of the above-described techniques such as by transferring from the seller's bank account (FIG. 5), and if such technique does not generate the proper amount of funds, the computer system (214) can seek to transfer the escrow amount or a portion of the escrow amount by another of the techniques such as by the above-mentioned instruction directing the EFP to transfer funds, as seen in FIG. 2.

In one embodiment, sales tax for non-bank card sales, e.g., cash sales could be escrowed, for example, by debiting it from the seller's business checking account and crediting an escrow account in the corresponding amount. For example, if sales tax is 6% and cash sales are $100, $6.00 would be debited from the seller's checking account and credited to the tax escrow account. Note that this implementation for escrowing amounts from non-bank card transactions involving transfers from the seller's bank account could be combined with the above-described method for escrowing amounts from bank card transactions involving EFP transfers. In a particular example, sales tax on non-bank card transactions can be escrowed via transfers from the seller's bank account to the escrow account, and sales tax on bank card transactions can be escrowed via transfers from the EFP to the escrow account.

In one exemplary implementation, the sales registry device or bank card terminal of the seller can be configured to collect and report three sales transaction totals associated with a closeout period: one total for bank card sales, another total for sales that are made using cash or other financial instruments, i.e., sales which can be referred to as “non-bank card” sales, and yet another total for non-taxable sales. This may be accomplished, for example, by programming of the sales registry device or POS terminal (conventional terminals, for example, have been programmed to prompt operators to report whether a transaction is taxable or non-taxable). For each tax jurisdiction, a computer system (14, FIG. 2; or 214, FIG. 5) can combine, i.e., add an amount associated with the bank card sales, with an amount associated with the non-bank card sales, subtract an amount associated with the non-taxable sales, and calculate an amount of tax to be escrowed based on one or more tax jurisdictions to which tax is owed and based on tax rates, e.g., percentages, imposed by the respective tax jurisdictions. The tax or taxes due on the combined sales amount can then be debited from an amount or amounts associated with the bank card transactions approved during a closeout period of the seller, and deposited into an escrow account. In such example, the merchant may retain all other funds received from the sales (and for example, may deposit these in the merchant bank account).

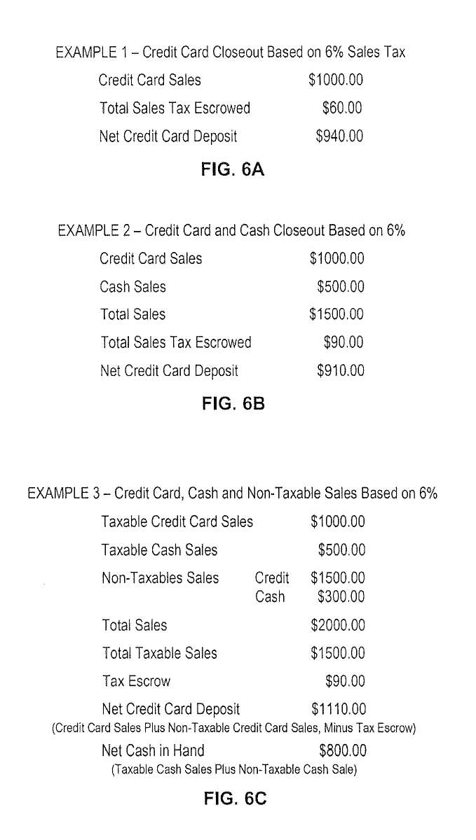

Three examples illustrating escrow transactions at the merchant terminal are illustrated in FIGS. 6A-6C. In FIG. 6A, all reported sales transaction in the closeout period are bank card sales, each owing a 6% tax in a tax jurisdiction. Total sales tax escrow is computer based on the tax rate and total bank card sales, a net deposit (less escrowed tax funds) based on the amount of the bank card transactions is deposited in the merchant account.

In FIG. 6B, total bank card and total non bank card sales are each reported for a closeout period, each owing a 6% tax in a particular tax jurisdiction. An amount of bank card sales is combined with an amount associated with cash and other non-bank card sales, and a total sales tax escrow is computed based on the tax rate and on total sales. A net deposit (less escrowed tax funds representing tax owed on the combined sales amount is deposited in the seller's account.

In FIG. 6C, both taxable and non-taxable bank card sales, and cash and other non-bank card sales totals are reported. For example, state laws may characterize certain sales as non-taxable. For example, clothes purchases in New Jersey are generally non-taxable. Each taxable sale may owe 6% tax in a particular tax jurisdiction. Taxable and non-taxable totals are prepared for both total bank card sales and the total non-bank card sales during the closeout period, and a total sales tax escrow is computed based on the tax rate and on total taxable sales in both categories. In addition, the bank card and non-bank card sales amounts for each closeout period can account for amounts deducted therefrom for refunds issued to customers and returns of previous purchases, such that these sales amounts net of refunds and returns are used when computing the amount to be transferred to the escrow account.

In one example, a total can be obtained by combining the amount of taxable sales of the bank card sales, with an amount of the taxable sales of the non-bank card sales. Amounts of tax calculated by the sales registry device or POS terminal for respective taxable bank card transactions as well as non-bank card transactions can be totaled to determine a tax escrow amount to be deposited in the escrow account. A net deposit representing an amount of the bank card sales less the escrow amount and any other applicable fees can then be deposited in the seller's account. In such example, funds from the non-bank card sales can remain on hand with the seller.

In addition to escrowing funds for sales tax owed on bank card sales as well as non-bank card sales, the above-disclosed method may be extended, for example, to sales made via the Internet, or made via mail, telephone or fax (hereinafter, Internet and mail/phone/fax sales). In order to extend the method accordingly, such sales may be identified with tax codes for taxable and non-taxable sales. Currently, these sales may only be taxable when the seller is based in the same state as the state in which the customer resides, or the state in which delivery is to be made. Sales tax may also be due on such sales when the seller has a retail outlet in the same state in which the customer resides or in the same state in which delivery is to be made, if different from the state in which the customer resides. As sales tax may be due on such sales, a seller must collect the sales tax of one or more tax jurisdictions which tax the sale, and pay such tax in accordance with that jurisdiction's tax laws. In one example, the applicable tax jurisdiction for a sale can be identified by information about the sale which is recorded at the time of the sale, or can be determined from the recorded sale information. A tax amount associated with the online transaction and the applicable tax authority can then be determined in accordance with a tax rate applicable to the Internet or mail/phone/fax transaction.

In addition to sales taxes, the methods described herein may be used to escrow funds for the payment of taxes other than sales taxes to a tax authority, such as a locality, a state, regional or provincial government, or a federal or national government. In a particular embodiment, the methods described herein can be utilized to set aside funds for the payment of use taxes or, alternatively, to directly pay use taxes. Although many states of the United States have laws requiring payment of taxes on out of state purchases (e.g., purchases which have not been taxed by another state), there has not generally been effective collection and enforcement of use taxes. The Marketplace Fairness Act currently pending in the United States Congress would require out of state Internet sellers and mail/phone/fax sellers to collect use taxes for a tax authority based on the residence location of the customer, the location to which goods are shipped or the location at which services are provided or deemed provided to the customer. Use taxes can be collected and escrowed for payment to the various tax authorities to which they are due by determining one or more appropriate tax authorities in effect when entering a transaction with a customer, marking the transaction with information representing the one or more tax authorities, and collecting use taxes for payment to the one or more tax authorities determined for the transaction.

As a result, such information may be collected and provided so that sales and use tax owed on Internet or mail/phone/fax sales within a closeout period can be collected, e.g., from bank card receipts closed during the period, and sales tax filings and payments for Internet and mail/phone/fax sales may be prepared on behalf of the seller by a tax preparer on a schedule and as required by each of multiple tax jurisdictions. In addition to collecting and paying sales and use tax from bank card sales made via the Internet or via mail/phone/fax, by using the method described above, sales and use tax may also be collected when sales are paid for with non-bank card instruments such as cash, personal check, money order, bank check, travelers check, gift check, gift certificate, pre-paid card, e-wallet, gift card as described above or other financial instrument.

As is further described herein, one example provides a method for collecting other taxes, liens, garnishments and levies that may be imposed on a seller by state and/or federal government agencies. For example, such method may provide for adjusting the rate of sales or use tax collection (or other tax collection) in order to address back taxes. In this manner, a seller may for example reimburse a state sales tax authority for back taxes owed at a manageable rate, until the back taxes are repaid. For example, in a case where taxable sales receipts are taxed at a rate of 6%, the escrow rate may be adjusted upward (for example, to 16%) in order to collect against back sales tax owing. Such method could be applied to virtually any application in which a seller desires or is otherwise required to effect a withholding of funds collected from bank card sales transactions, and for payment of escrowed merchant funds to any legitimate payee (for example, local, state and federal tax authorities, judicial authorities, and payees who have received legal judgments against a seller). For example, in addition to the applications previously disclosed, it is contemplated that the method could be applied to generate escrow funds for paying back payroll taxes or back real estate taxes, or for effecting a savings account for seller (in the latter case, the payee of funds escrowed would be the seller).

It is also contemplated that the present method may be used for the purpose of creating multiple escrow funds simultaneously. For example, the seller could specify more than one escrow rate each to be applied to one or more classes of eligible sales transactions. The seller in such case may provide advance directives which identify tax authorities or parties to whom associated escrowed funds are to be disbursed in accordance with applicable tax rates, or in accordance with escrow rates as specified by the seller. Such directives may then be stored as information, e.g., a template, for use by computer system, e.g., system (14, FIG. 2; or 214, FIG. 5) in performing escrow or payment operations. Based on the stored information, the computer system could then transmit instructions directing the EFP or merchant back to transfer specific amounts for each closeout period in accordance with the advance directives of the seller and in accordance with a sales amount for at least one transaction during the closeout period. In a particular embodiment, the seller may be given an opportunity to review and approve transfer of specific amounts of funds before such transfers are made.

In any or all of the examples provided herein in which a seller or other person or entity has an input in directing the transfer of funds, the computer system may provide a secure interface, e.g., requiring authentication, encryption, and possibly a certificate or digital signature, with which the seller or other person or entity can exchange information, or provide an advance directive to the computer system, for example. Thus, when amounts to be escrowed are associated with garnishments, e.g., legal judgments, the secure interface may be accessible by a party other than the seller.

In addition to the above-described ways in which funds can be escrowed for payment of current and/or back taxes, in a particular embodiment, the seller may select a particular person, business or organization as a payee to whom a portion of the funds collected by an EFP based on the seller's transactions is to be credited. In one such example, a portion of the seller's receipts collected by an EFP for a closeout period can be credited to an account for payment to a lender or other business which extends credit to the seller in some way. In such case, the seller effectively grants the lender or other business a right to a portion of its accounts receivables, which that lender or business can then receive via fund transfers made by the EFP out of the seller's incoming bank card payment stream. The fund transfers can be fixed or variable amounts, or a variable amount with a fixed floor amount, fixed ceiling amount, or both, and in particular cases the amounts may be calculated as a percentage of the bank card receipts for the closeout period. As in the above examples, the parties may alternatively agree to calculate amounts to transfer to the lender which are based on the total receipts of the seller for both bank card and non-bank card transactions, even though the amounts actually transferred to the lender may come entirely out of the bank card receipts in an example similar to the process which is described above relative to FIG. 2.

Thus, in a concrete example, a restaurant may receive food on credit from a wholesaler with an agreement for the wholesaler to receive up to 10% of the restaurant's daily bank card and non-bank card receipts in payment for the food. In such case, an advance directive can be provided to the computer system (14, FIG. 2; or 214, FIG. 5) to implement this payment agreement between the restaurant and the wholesaler. At the end of each day (or other closeout period) computer system (14 or 214), in turn, can issue instructions to an EFP, similar to the above-described example of FIG. 2, or to an institution at which the seller (the restaurant business) banks, similar to the above-described example of FIG. 5, to transfer a certain amount of funds to an escrow account, which can be calculated by the computer system relative to the total bank card and non-bank card receipts of the restaurant for the day, or other closeout period.

In a particular example, the computer system may store information relating to a payee, e.g., the wholesaler in the restaurant example, such that the computer system (14, 214) can instruct the EFP, or alternatively the institution at which the seller has a deposit account, to transfer funds directly to an account of the payee as a fixed or variable portion of the bank card sales of the seller during the closeout period.

In a further example, the method may further include a function to provide information about escrowed funds to the seller, and to each tax jurisdiction in which sales tax receipts are being filed. As described herein, escrow account information can be provided at the seller terminal at the time of a close out in a form, for example, similar to the sales draft created by a sales registry device, e.g., POS terminal in response to each sales transaction. In addition, the method may additionally involve use of escrow account management software which can be periodically used by an escrow agent, for example, to report a monthly summary to the seller, and/or to prepare a filing return for filing tax receipts in a tax jurisdiction. If one or more types of funds are being escrowed, the monthly summary to the seller may for example report the following information for each type: a) escrow funds collected over a current closeout period, and cumulatively for a designated number of prior closeout periods, b) escrow funds paid for a current payment period and cumulatively for a designated number of prior payment periods, and c) balance of funds owed (if the fund type relates, for example, to back taxes or other obligations not relieved in a single payment period).

The escrow agent may for example provide a secure web site for presenting escrow account information to the seller and/or other payees (for example, the tax authorities). Alternatively, the escrow agent may physically or electronically transmit (for example, by e-mail, facsimile or other e-commerce means) escrow account information on a periodic basis directly to the seller and/or payee.

Additional applications of the method beyond sales tax collection for account transactions include any and all taxes that can be paid or charged for a sale, for example, a consumption tax such as a Value Added Tax or VAT which may be imposed thereon. A VAT as used herein is a type of consumption tax that is placed on a product whenever value is added at a stage of production and at final sale.

Summarizing, an advantage of the method and system according to an embodiment of the invention is that only amounts received for goods or services sold by the seller can be transferred to the seller's account, while the appropriate tax amount can be transferred to an escrow account for payment to a tax authority, or alternatively, paid to the tax authority without be transferred to the escrow account first. This escrow amount could be paid monthly or quarterly or any other interval, for example to a state or locality where the transaction is deemed to be taxable, in a way that can be done accurately and with relatively little or no intervention on the part of the seller.

Many present EFT systems provide effective security, for example such as encryption, as for moving money between accounts. The disclosed method may also operate with a secure web-based account available to the seller that enables the seller to check the status of their account with the escrow agent. In addition, as an alternative to the reporting of the non-bank card transactions by the seller or merchant, a web-based account may be provided to allow communications from the seller or merchant to the computer system with regard to such transactions.

The disclosed method may be used to exempt purchases made outside of a prescribed jurisdictional tax base. Alternatively, the method may be applied for multiple jurisdictions, for example, on a local level, state-by-state level, provincial level and/or national level. The method may also be applied to extract a service fee applied by the EFP.

The system and method can be customized to address any tax collection that involves tax liens and levies used by the local, state and federal governments to collect back taxes from businesses whether small or large, or even to collect back taxes from individual sellers who may not be regularly engaged in a business. For example, many small and large businesses fall behind on taxes for any number of reasons and paying back taxes becomes very difficult and expensive for sellers because of penalties and interest and because businesses rarely have large chunks of excess funds to pay back taxes. The collection of back taxes by state and federal governments is also a difficult and expensive job because it involves manpower.

The disclosed method can be utilized by a local, state or federal government to levy a seller, e.g., a business for back taxes. For example, suppose a business owes back sales tax to a state. In such example, the state sales tax can be 6%, but the state may levy the seller at a rate of 16% each month so as to collect an additional 10% towards back taxes until the debt is paid. In one example, the disclosed method can be employed to transfer amounts by an EFP or by the seller's financial institution to an escrow account or even directly to a tax authority of the local, state or federal government. In such case, the computer system, e.g., system (14, FIG. 2; or 214, FIG. 5), together with the EFP or the seller's financial institution, can act as collection agents for the local, state or federal government. In this way, it may be possible to reduce collection costs of the local, state or federal government, while distributing the tax levies or garnishments over a number of sales intervals which allow the sellers to continue operating. Thus, use of such method to distribute the collection of back taxes over many sales intervals may in some cases decrease the likelihood of further default by the seller, and thereby increase the likelihood that the back taxes will be repaid. Such method may also be used by collection companies to collect payment on judgments, which in some cases may also be distributed over a number of sales intervals.

The method may further involve one or more of the following:

directing an electronic processor of funds (EFP) associated with an online transaction to withhold the tax amount for payment to an applicable tax authority;
directing an electronic processor of funds (EFP) associated with the online transaction to credit an escrow account with the tax amount; or
directing an institution to withdraw the tax amount from an account of the seller for payment to the applicable tax authority.

In a particular example, the tax amount can be determined in accordance with a sale amount of an online transaction. This may be the case, for example, when the tax amount is for payment of sales or use tax in many jurisdictions.

In a particular example, the applicable tax rate can comprise a first applicable tax authority and a second applicable tax authority, and the step of determining can include determining a first tax amount associated with the online transaction and the first applicable tax authority, and a second tax amount associated with the online transaction and the second applicable tax authority. For example, for a particular transaction, the State of New York and the City of New York may each impose sales or use tax on the transaction at a respective rate. A later step of transferring or withdrawing funds for credit to an escrow account or payment to a tax authority can be performed according to the first and second tax amounts.

In another example, the step of determining a tax amount can be performed based at least partly on a sale amount of the transaction, and the step of transferring or withdrawing or crediting an amount to an account comprises directing the EFP or a financial institution holding an account of the seller to credit an escrow account with the tax amount.

The disclosed method may also be used by businesses, particularly small businesses, to provide a forced savings plan. Many small businesses are S corporations with profits flowing through to the officers as income. To boost this income the computer system can direct the transfer of funds from an EFP or financial institution into a savings account for the corporation. Many small businesses lack the discipline to save small amounts of money over time, a proven method of saving money. If the EFP offered the disclosed service to deduct an allocatable percentage from each transaction and funnel it, for example, into a bank-managed savings account digitally for the business, a whole new avenue of income is provided for the bank.

A variety of service providers may be selected to serve in the roles of EFP and escrow agent (for example, First Data Corporation, Telecheck, Chase Paymentech, and dozens of others).

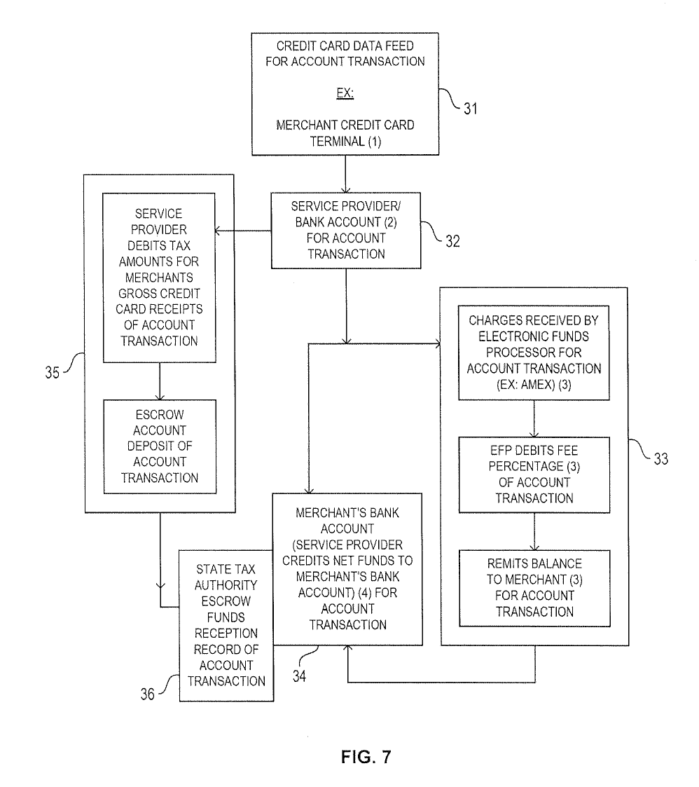

FIG. 7 provides another view of the disclosed method. A bank card and data feed as shown in box 31 interlinks with a bank network (EFP) as shown in box 32. Charges, i.e., transaction funds are received by the EFP as shown in box 33. The EFP debits a fee percentage, and remits the balance to the merchant's bank account, as shown in box 34. At the same time, the EFP debits an allocated tax amount for a retailer's gross bank card receipts, and makes an escrow account deposit to the escrow account as shown in box 35.

Several pricing models may be used to derive revenues from the escrow account services and functionality provided. A first approach is for a computer system (e.g., computer system (14) of FIG. 2) which directs the EFP and/or escrow agent to escrow funds, to charge based on a percentage figure of the overall value of escrow account transactions. A second method is for the computer system to charge a flat fee for every escrow account transaction regardless of dollar amount. A third approach is for the computer system to charge a transactional fee based upon the volume of escrow account transactions processed.

As these and other variations and combinations of the features discussed above can be utilized without departing from the present invention as defined by the claims, the foregoing description of the preferred embodiments should be taken by way of illustration rather than by way of limitation of the invention as defined by the claims.

1. A computer-implemented method performed by at least one computer system for segregating funds associated with transactions of a seller to provide a source of funds available for payment to a payee, the method comprising:
(a) storing data relating to a seller;
(b) determining a sales amount corresponding to one or more transactions of the seller associated with a closeout period;
(c) determining an escrow amount based on the sales amount and a tax rate applicable to the one or more transactions; and
(d) transmitting an instruction to an electronic funds processor (EFP) to direct the EFP to credit an escrow account with the escrow amount when the sales amount equals or exceeds the escrow amount.

2. The method of claim 1, wherein step (a) comprises determining a sales amount associated with a sales registry device, and the sales registry device is configured to communicate information for authorization of and entry of the one or more transactions over a wireless communication interface.

3. The method of claim 2, wherein the sales registry device comprises a mobile computing device having an open industry platform configured to permit user-reconfiguration thereof by installation of program software.

4. The method of claim 3, wherein the mobile computing device is configured to receive information from a card via a mobile card reader, and to transmit an authorization request for at least one transaction based on the received information.

5. The method of claim 1, wherein the sales amount is associated with a sales registry device and the sales registry device comprises a point of sale terminal.

6. The method of claim 1, wherein step (b) includes determining a first sales amount associated with one or more non-bank card transactions during the closeout period, and
determining a second sales amount associated with one or more bank card transactions during the closeout period,
and the step of transmitting an instruction to the EFP includes transmitting an instruction to direct the EFP to credit the escrow account with the escrow amount when the second sales amount at least equals the escrow amount.

7. The method of claim 6, wherein the first and second sales amounts are determined using information transmitted from at least one sales registry device, the sales registry device including at least one point of sale terminal of the seller.

8. The method of claim 6, wherein the one or more non-bank card transactions are each facilitated using a payment instrument selected from the group consisting of personal checks, money orders, bank checks, travelers checks, gift checks, gift certificates, pre-paid cards, e-wallets, gift cards and cash.

9. The method of claim 1 further comprising:
determining a payable amount to be paid from the escrow account; and
directing an institution to debit the payable amount from the escrow account for payment to a tax authority.

10. The method of claim 9, wherein the step of directing an institution to debit the payable amount from the escrow account includes transmitting at least one instruction from a first computer system to a second computer system associated with the institution, the at least one instruction including information representative of the account and the tax payable amount.

11. The method of claim 6 further comprising:
registering a third sales amount based on at least one of the first or second sales amounts corresponding to each of a plurality of closeout periods within a predetermined tax reporting interval, the registering performed using information received from the at least one sales registry device representing the sale amount in each of the closeout periods; and
preparing and transmitting a tax return for the predetermined tax reporting interval to a reporting authority based on the third sales amount.

12. A system for segregating funds associated with transactions of a seller to provide a source of funds available for payment to a payee, comprising:
a computer system; and
instructions executable by the computer system to perform a method comprising:
(a) storing data relating to a seller;
(b) determining a sales amount corresponding to one or more transactions of the seller associated with a closeout period;
(c) determining an escrow amount based on the sales amount and a tax rate applicable to the one or more transactions; and
(d) transmitting an instruction to an EFP to direct the EFP to credit an escrow account with the escrow amount when the sales amount equals or exceeds the escrow amount.

13. The system of claim 12, further comprising a sales registry device, wherein step (a) comprises receiving information relating to one or more transactions associated with the sales registry device during the closeout period, wherein the sales registry device is of a type configured to communicate information for authorization of and entry of the one or more transactions over a wireless communication interface.

14. The system of claim 13, wherein the information relating to the one or more transactions is associated with a sales registry device of a type comprising an open industry platform configured to permit user-reconfiguration thereof by installation of program software.

15. The system of claim 14, wherein the sales registry device comprises a smartphone.

16. The system of claim 12, further comprising at least one sales registry device having a point of sale terminal for providing the information relating to the one or more transactions.

17. The system of claim 12, wherein step (b) includes determining a first sales amount associated with one or more non-bank card transactions during the closeout period,
determining a second sales amount associated with one or more bank card transactions during the closeout period,
and the step of transmitting an instruction to the EFP transmits an instruction to direct the EFP to credit the escrow account with the escrow amount when the second sales amount at least equals the escrow amount.

18. The system of claim 17, wherein step (b) includes determining the first and second sales amounts using information associated with the closeout period transmitted from at least one sales registry device.

19. The system of claim 12, further comprising:
determining a payable amount to be paid from the escrow account; and
directing an institution to debit the payable amount from the escrow account for payment to a tax authority.

20. The system of claim 19, wherein the step of directing an institution to debit the payable amount from the escrow account includes transmitting at least one instruction from a first computer system to a second computer system associated with the institution, the at least one instruction including information representative of the account and the tax payable amount.

21. The system of claim 17,
wherein the instructions further include instructions executable by the computer system to register a third sales amount based on at least one of the first or second sales amounts corresponding to each of a plurality of closeout periods within a predetermined tax reporting interval, the registering performed using information received from at least one sales registry device representing the sales amount in each of the closeout periods, and the instructions further including instructions executable by the computer system to prepare and transmit a tax return for the predetermined tax reporting interval to a reporting authority based on the third sales amount.

22. A tangible storage medium having computer-readable instructions recorded thereon, the instructions being executable by a computer system to perform a method, the method comprising:
(a) storing data relating to a seller;
(b) determining a sales amount corresponding to one or more transactions of the seller associated with a closeout period;
(c) determining an escrow amount based on the sales amount and a tax rate applicable to the one or more transactions; and
(d) transmitting an instruction to an EFP to direct the EFP to credit an escrow account with the escrow amount when the sales amount equals or exceeds the escrow amount.

23. The tangible storage medium of claim 22, wherein step (b) comprises receiving information relating to one or more transactions associated with at least one sales registry device, wherein the sales registry device is of a type configured to communicate information of the one or more transactions over a wireless communication interface.

24. The tangible storage medium of claim 23, wherein the sales registry device comprises an open industry platform configured to permit user-reconfiguration thereof by installation of program software.

25. The tangible storage medium of claim 22, wherein step (b) includes determining a first sales amount associated with one or more non-bank card transactions during the closeout period,
determining a second sales amount associated with one or more bank card transactions during the closeout period,
and the step of transmitting an instruction to the EFP transmits an instruction to direct the EFP to credit the escrow account with the escrow amount when the second sales amount equals or exceeds the escrow amount.

26. The tangible storage medium of claim 25, wherein step (b) comprises determining the first and second sales amounts using information received from at least one sales registry device.

27. The tangible storage medium of claim 22, further comprising:
determining a payable amount to be paid from the escrow account; and
directing an institution to debit the payable amount from the escrow account for payment to a tax authority.

28. The tangible storage medium of claim 25, wherein the instructions further comprise instructions which are executable to register a third sales amount based on at least one of the first or second sales amounts corresponding to each of a plurality of closeout periods within a predetermined tax reporting interval, the registering performed using information received from the at least one sales registry device representing the sale amounts in each of the closeout periods; and
to transmit a tax return for the predetermined tax reporting interval to a reporting authority based on the third sales amount.

29. A computer-implemented method performed by at least one computer system for directing funds associated with transactions of a seller for payment to a payee, the method comprising:
(a) storing data relating to a seller and at least one payee to whom payment is to be made;
(b) determining a sales amount corresponding to one or more transactions of the seller associated with a closeout period;
(c) determining a tax payable amount based on the sales amount and a tax rate applicable to the one or more transactions; and
(d) transmitting an instruction to an EFP to direct the EFP to credit the payee with the tax payable amount when the sales amount equals or exceeds the tax payable amount.

30. The method of claim 29, wherein step (a) comprises determining a sales amount associated with a sales registry device, wherein the sales registry device is of a type configured to communicate information of the one or more transactions over a wireless communication interface.

31. The method of claim 30, wherein the sales registry device comprises a portable open industry computing platform configured to permit user-reconfiguration thereof by installation of program software.

32. The method of claim 30, wherein the portable open industry computing platform further comprises a mobile card reader, wherein the sales registry device is configured to receive information associated with a customer account from a card via the mobile card reader, and is configured to transmit an authorization request for a transaction of the one or more transactions based on the received customer account information.

33. The method of claim 29, wherein step (b) includes determining a first sales amount associated with one or more non-bank card transactions during the closeout period, and
determining a second sales amount associated with one or more bank card transactions during the closeout period,
and the step of transmitting an instruction to the EFP includes transmitting an instruction to direct the EFP to credit the account of the payee with the tax payable amount when the second sales amount equals or exceeds the tax payable amount.

34. The method of claim 33, wherein the first and second sales amounts are determined using information transmitted from at least one sales registry device.

35. The method of claim 33, wherein the step of determining the tax payable amount comprises determining a payable amount as one amount selected from, or the sum of two or more amounts selected from the group consisting of:
(i) an amount estimated to pay a predetermined sum from one or more of the first and second sales amounts over a predetermined number of closeout periods, wherein the estimated amount can be fixed or can vary during the predetermined number of closeout periods,
(ii) an amount being a predetermined percentage of one or more of the first and second sales amounts, or
(iii) an amount being a sum of a predetermined percentage of at least one of the first and second sales amounts,
wherein said predetermined percentage comprises at least one of:
(i) the seller tax rate, or
(ii) an estimate for paying the predetermined sum from the one or more of the first and second sales amounts over a predetermined number of sales periods.

36. The method of claim 29, wherein the step of directing the EFP to credit the payee with the tax payable amount includes transmitting at least one instruction from a first computer system to a second computer system associated with the institution, the at least one instruction including information representative of an account of the payee and the tax payable amount.

37. The method of claim 33, further comprising:
registering a third sales amount based on at least one of the first or second sales amounts corresponding to each of a number of closeout periods within a predetermined tax reporting interval; and
transmitting a tax return for the predetermined tax reporting interval to a reporting authority based on the third sales amount.

38. A computer-implemented method performed by at least one computer system for impounding escrow funds associated with transactions of a seller, the method comprising the steps of:
(a) storing data relating to a seller;
(b) determining a sales amount corresponding to one or more transactions of the seller associated with a closeout period;
(c) determining an escrow amount based on the sales amount and a tax rate applicable to the one or more transactions; and
(d) transmitting an instruction to an institution to direct the institution to transfer the escrow amount from an account of the seller to an escrow account when the sales amount equals or exceeds the escrow amount.

39. The method of claim 38, further comprising:
determining a payable amount to be paid from the escrow account; and
directing an institution to debit the payable amount from the escrow account for payment to a payee.

40. The method of claim 39, wherein step (d) is performed by a first computer system and the step of directing an institution to debit the payable amount from the escrow account includes transmitting at least one instruction from a first computer system to a second computer system associated with the institution, the at least one instruction including information representative of the account and the payable amount.

41. A computer-implemented method performed by at least one computer system for impounding escrow funds associated with transactions of a seller, the method comprising the steps of:
(a) storing data relating to a seller, and at least one payee to whom payment is to be made;
(b) determining a sales amount corresponding to one or more transactions of the seller associated with a closeout;
(c) determining a tax payable amount based on the sales amount and a tax rate applicable to the one or more transactions; and
(d) transmitting an instruction to an institution to direct the institution to transfer the tax payable amount from an account of the seller for credit to the payee when the sales amount equals or exceeds the tax payable amount.

42. The method of claim 41, wherein the step of transmitting the instruction to the institution includes transmitting at least one instruction from a first computer system to a second computer system associated with the institution, the at least one instruction including information representative of the account and the tax payable amount.

43. A computer-implemented method performed by at least one computer system for directing funds associated with an online transaction between a buyer and a seller for payment to a payee, the method comprising:
(a) determining an applicable tax authority which may tax the online transaction from among a plurality of tax authorities, the applicable tax authority determined based at least partly on data relating to at least one of the buyer or a location to which goods or services are provided or deemed provided in accordance with the transaction;
(b) determining a tax amount associated with the online transaction in accordance with the applicable tax authority and a tax rate applicable to the online transaction; and
(c) performing at least one of:
directing an EFP associated with the online transaction to withhold the tax amount for payment to the applicable tax authority;
directing an EFP associated with the online transaction to credit an escrow account with the tax amount;
directing an institution to withdraw the tax amount from an account of the seller for payment to the applicable tax authority; or
directing an institution to transfer the tax amount from an account of the seller and credit an escrow account with the tax amount.

44. The method of claim 43, wherein step (b) further determines the tax amount in accordance with the sale amount of the online transaction.

45. The method of claim 43, wherein the applicable tax authority determined in step (a) comprises a first applicable tax authority and a second applicable tax authority, and step (b) includes determining a first tax amount associated with the online transaction and the first applicable tax authority, and a second tax amount associated with the online transaction and the second applicable tax authority, and step (c) is performed with respect to each of the first and second tax amounts.

46. The method of claim 43, wherein step (b) is performed based at least partly on a sale amount of the transaction, and step (c) comprises directing the EFP to credit an escrow account with the tax amount.
